(19) United States
(12) Patent Application Publication
(10) Pub. No.: US 2014/0179140 A1
(43) Pub. Date: Jun. 26, 2014

(54) ADJUSTABLE BUS BAR CONNECTION INTERFACE

(71) Applicants: Stephen Scott, Fenton, MI (US); Bert Mohr, Ann Arbor, MI (US)

(72) Inventors: Stephen Scott, Fenton, MI (US); Bert Mohr, Ann Arbor, MI (US)

(21) Appl. No.: 14/136,669

(22) Filed: Dec. 20, 2013

Related U.S. Application Data
(60) Provisional application No. 61/740,005, filed on Dec. 20, 2012.

(51) Int. Cl. H01R 13/02

(52) U.S. Cl. CPC H01R 13/02
USPC 439/246

(57) ABSTRACT

A bus bar connection interface including a first conductor having a first end, a second end, and a cavity, an insert of electrically conductive material having a top end, a bottom end, and a waist portion therebetween and the insert being configured to fit into the cavity of the first conductor such that the insert and the first conductor are in electrical communication. A second conductor having a first end and a second end configured to receive the insert such that the insert and the second conductor are in electrical communication when engaged. The waist of the insert being in contact with the second conductor and at least one of the top end and the bottom end of the insert being in contact with the first conductor to maintain electrical conductivity between the first conductor and the second conductor.

### CROSS REFERENCE TO RELATED APPLICATION

This application claims the benefit of application Ser. No. 61/740,005 filed Dec. 20, 2012.

### BACKGROUND OF THE INVENTION

Bus bars in high powered modules have presented a challenge for the location and connection to circuit boards due tolerance concerns when stacking up various components. Currently, flexible bus bars that exist are designed with either flexible woven strands or thin layers of copper alloy stacked on top of each other allowing flexibility. These types of bus bars can be very expensive, difficult to assemble, and even more difficult to locate. It is therefore desirable to come up with improvements to bus bar connections in general, and to bus bar connections for hybrid vehicles in particular.

### SUMMARY OF THE INVENTION

Advantages of the present invention include a system for a floating bus bar connection interface. A first conductor, an electrically conductive insert, and a second conductor inserted into the first conductor and engaging the insert allows the second conductor to move or float in relation to the first conductor while the insert maintains electrical communication between the first and second conductors.

Another advantage of the present invention includes a plurality of weakening strips in the insert which bend to allow deformation of the insert with respect to the conductors. The weakening strips of the insert bend at the waist of the insert to allow lateral movement of one of the conductors with respect to the other conductor. Additionally, one of the conductors may take a plurality of longitudinal positions with respect to the other conductor while maintaining electrical communication.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view showing the bus bar connection interface of the present invention connected to an electric motor and circuit board of a hybrid vehicle.

FIG. 2 is a perspective view showing the top of the bus bar connection interface.

FIG. 3 is a front view showing the plurality of longitudinal strips of the insert.

FIG. 4 is a perspective view showing the bottom of the bus bar connection interface.

### DETAILED DESCRIPTION OF THE ENABLING EMBODIMENTS

Referring to the Figures, wherein like numerals indicate corresponding parts throughout the several views, a system for a bus bar connection interface 10 is provided.

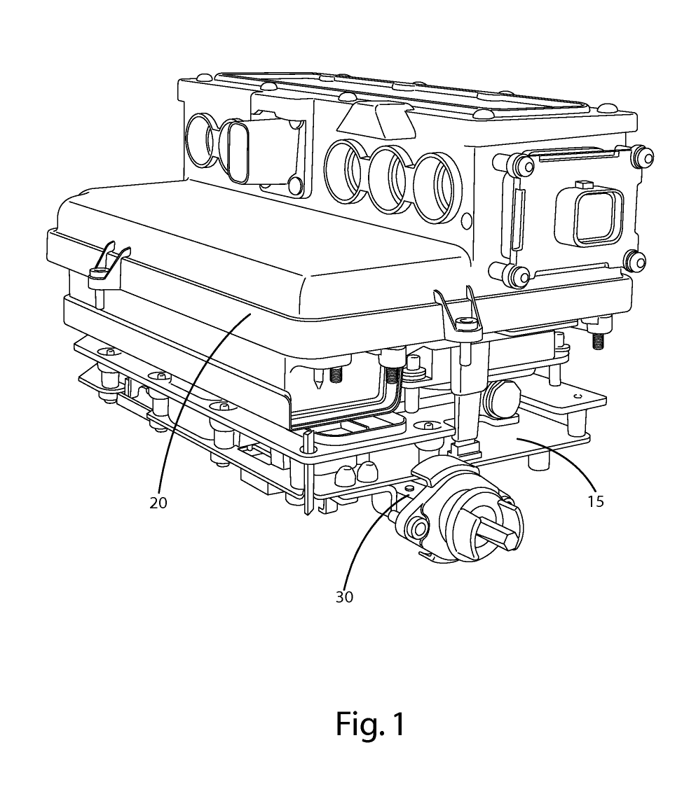

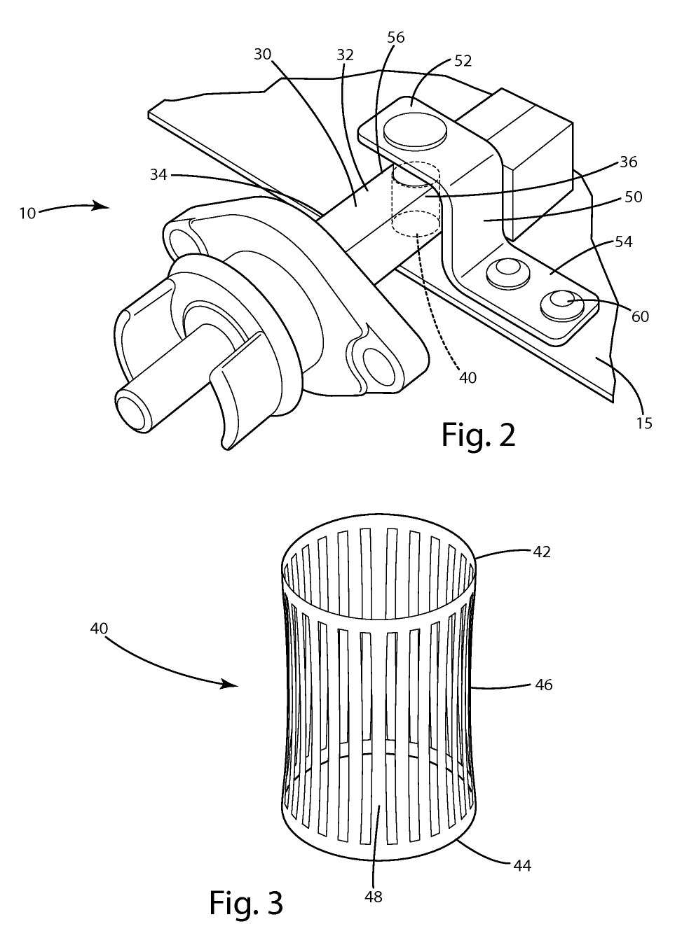

FIG. 1 illustrates the bus bar connection interface 10 in use, connecting the power supply of a hybrid vehicle with a circuit board 15 and electric motor 20 to allow current to flow from the power supply to where power is needed in the hybrid vehicle. FIG. 2 illustrates an exemplary embodiment of the bus bar connection interface 10. To create the bus bar connection interface 10, a first conductor 30 having a first end 30 and a second end 34 is utilized. The first end 32 of the first conductor 30 defines a cavity 36 or hole extending partially or entirely through the first conductor 30. The cavity 36 or hole may preferably resemble a cylindrical opening. It should also be noted that the first conductor 30 may be produced from any electrically conductive material, and as such, the first conductor 30 is also a first bus bar.

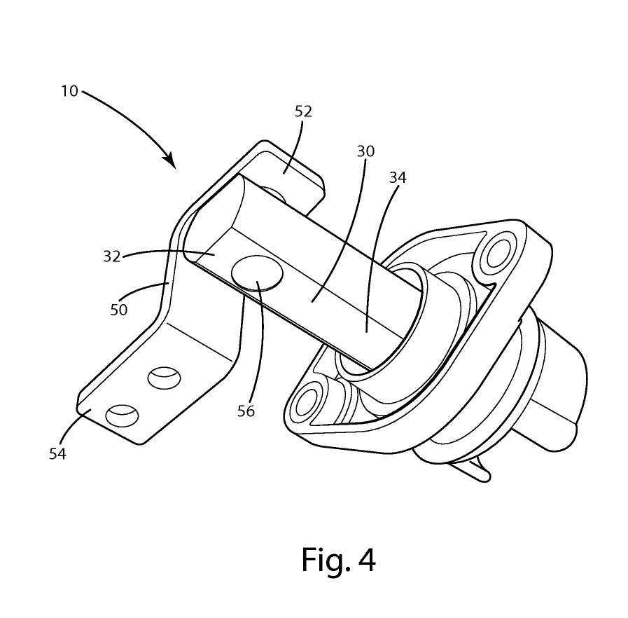

As shown in FIGS. 2 and 3, an insert 40 having a top end 42, a bottom end 44, and a waist portion 46 extending between the top end 42 and bottom end 44 is also utilized for the bus bar connection interface 10. The insert 40 is preferably made from an electrically conductive silver plated copper alloy; however, any other material having similar high amperage conductive properties may be utilized. The top end 42 and the bottom end 44 of the insert 40 may have a greater circumference than the waist portion 46, therefore the insert 40 may resemble a generally hyperboloid shape. It should be noted that any similarly circumferential shape may also be used so long as it produces similar contact as discussed in greater detail below. Additionally, the top end 42 of the insert 40 may be referred to as an outlet and the bottom end 44 may be referred to as an inlet. This notation is simply used as an identifier of the ends 42, 44 and should not be considered limiting as the flow of electricity may travel into the inlet and out of the outlet, or into the outlet and out of the inlet when electricity is traveling through the bus bar connection interface 10. As shown in FIG. 3, the insert 40 may also have weakening strips 48 extending longitudinally between the top end 42 and the bottom end 44, the significance of which will be described in greater detail below.

As shown in FIGS. 2 and 4, a second conductor 50 may be utilized to transfer electricity to or from the first conductor 30. The second conductor 50, in one embodiment, may have a first end 52 and a second end 54 and a generally L-shape extending therebetween. It should be noted that the second conductor 50 is not limited to an L-shape, various other design shapes may be utilized while realizing similar results. Additionally, the second conductor 50 may have a flange 56 extending perpendicularly away from the first end 52 of the second conductor 50. To engage the insert 40 and/or the first conductor 30, the second conductor 50 may also utilize a flange 56 having a tubular shape, or any shape configured to fit into the cavity 36 of the first conductor or either the top end 42 or the bottom end 44 of the insert 40. When engaged to the first conductor 30 via the insert 40, the first conductor 30 and the second conductor 50 are in electrical communication. It should also be noted that the second conductor 50 may be produced from any electrically conductive material, and as such, the second conductor 50 is also a second bus bar.

The bus bar connection interface 10 is preferably generated by engaging the flange 56, or any portion, of the second conductor 50 into the insert 40. Preferably, the flange 56 of the second conductor 50 is inserted or placed into the insert 40 such that the waist portion 46 of the insert 40 engages the second conductor 50. Additionally, the insert 40 is put into the cavity 36 of the first conductor 30 such that the first conductor 30 engages at least one of the top end 42 and the bottom end 44 of the insert 40.

The weakening strips 48 of the insert 40 allow the insert 40 to bend and deform, permitting lateral movement of the second conductor 50 with respect to the first conductor 30. It should be noted that, with the waist portion 46 in contact with the second conductor 50 and at least one of the top end 42 and the bottom end 44 of the insert 40 in contact with the first conductor 30, the second conductor 50 may take a plurality of longitudinal positions within the first conductor 30 while maintaining electrical communication between the first conductor 30 and the second conductor 50. As such, the second conductor 50 may be thought of as floating or movable to allow for various stackups or power supply while maintaining the flow of current between the first conductor 30 and the second conductor 50 through the insert 40.

The mating feature of the two bus bars to create the bus bar connection interface 10 gives vertical freedom while maintaining a high powered connection. Freedom in the other two axial directions at the circuit board 15 level by making the electrical bus bar connection interface 10 an open area is also available. Such freedom is generated by utilizing large slotted screws 60 to clamp down one of the bus bars to a circuit board 15 or other place where power must be transmitted to or from. It should be noted that other fastening means may be utilized, such as, but not limited to, a clamp, screws, or soldering. With this configuration, even though the parts are all of rigid design, it allows for adjustability in all three axis while maintaining a top down assembly process.

Uses for a bus bar connection interface 10 as disclosed herein include transmission of power in a hybrid vehicle, or any vehicle, between a power source to a place where power is needed. A power source may include, but is not limited to, a battery panel, electric motor, generator, or a capacitor, such as a bulk capacitor. The place where power is needed may include, but is not limited to, a circuit board, an amplifier, an electric motor, a generator, a capacitor, a resistor, an antenna, or another conductor, such as a third conductor. A panel mount type bus bar connection interface is shown in the figures to demonstrate the adjustability of the interface. Additionally, it should be noted that the present invention is not limited to hybrid vehicles or to any type of vehicle in general. The present invention may be utilized any place a bus bar is necessary to transfer a high amperage current and adjustability is desired.

Obviously, many modifications and variations of the present invention are possible in light of the above teachings and may be practiced otherwise than as specifically described while within the scope of the appended claims. Furthermore, the foregoing discussion discloses and describes merely exemplary embodiments of the present invention. One skilled in the art will readily recognize from such discussion, and from the accompanying drawings and claims, that various changes, modifications and variations may be made therein without department from the spirit and scope of the invention as defined in the following claims. The use of the word “said” in the claims refers to an antecedent that is a positive recitation meant to be included in the coverage of the claims whereas the word “the” precedes a word not meant to be included in the coverage of the claims.

What is claimed is:

1. A system for a bus bar connection interface comprising;
a first conductor having a first end and a second end and said first end defining a cavity,
an insert of electrically conductive material having a top end, a bottom end, and a waist portion therebetween, said insert configured to fit into said cavity of said first conductor such that said insert and said first conductor are in electrical communication,
a second conductor having a first end and a second end and said first end configured to receive said insert such that said insert and said second conductor are in electrical communication, and
said waist of said insert being in contact with said second conductor and at least one of said top end and said bottom end of said insert being in contact with said first conductor to maintain electrical conductivity between said first conductor and said second conductor.

2. The system of claim 1 wherein said first conductor is a bus bar.

3. The system of claim 1 wherein said second conductor is a bus bar.

4. The system of claim 1 wherein said insert is made from a high amperage electrically conductive material.

5. The system of claim 4 wherein said insert is made of silver plated copper alloy.

6. The system of claim 1 wherein said first end and said second end and said waist of said insert define a generally hyperboloid shape such that said first end and said second end of said insert have a greater circumference than said waist.

7. The system of claim 1 wherein said second conductor has a generally L-shaped configuration between said first end and said second end.

8. The system of claim 1 wherein said second end of said conductor is configured to transmit electricity to an electrical component.

9. The system of claim 8 wherein said electrical component is at least one of an electric motor, a circuit board, a generator, an amplifier, a capacitor, a resistor, an antenna, and a third conductor.

10. The system of claim 1 wherein said insert further includes a plurality of weakening strips extending longitudinally between said top end and said bottom end.

11. The system of claim 10 wherein said plurality of weakening strips are deformable at said waist when said insert engages said second conductor to provide a plurality of longitudinal positions for said second conductor relative to said first conductor.

12. The system of claim 10 wherein said plurality of weakening strips are deformable at said waist to allow lateral movement of said second conductor relative to said first conductor.

13. The system of claim 1 wherein electric current flows between said first conductor and said second conductor through said insert.

14. The system of claim 1 wherein said bottom end of said insert is an inlet for electricity traveling from said first conductor and wherein said top end of said insert is an outlet for electricity traveling to said second conductor.

15. The system of claim wherein said top end of said insert is an inlet for electricity travelling from said second conductor and wherein said top end of said insert is an outlet for electricity traveling to said first conductor.

16. A system for a bus bar connection interface comprising;
a first conductor having a first end and a second end, said first end of said first conductor defining a cavity, and wherein first conductor is a first bus bar,
an insert of electrically conductive silver plated copper alloy having a top end, a bottom end, and a waist portion extending therebetween to define a generally hyperboloid shape, said bottom end being an inlet and said top end being an outlet, said inlet and said outlet of said insert having a greater circumference than said waist, said insert having weakening strips extending longitudinally between said top end and said bottom end,
a second conductor having a first end and an second end and a generally L-shape extending therebetween and a flange of tubular shape extending perpendicularly away from said first end of said second conductor, and wherein said second conductor is a second bus bar,
said flange on said second conductor configured to fit into said insert such that said insert and said second conductor are in electrical communication;
said second conductor being inserted into said top end of said insert and said insert engaging said second conductor allowing said weakening strips to bend to allow deformation of said waist with respect to said second conductor,
said bottom end of said insert being inserted into said cavity of said first conductor and said first conductor engaging said insert allowing said weakening strips to bend at said waist to allow lateral movement of said second conductor with respect to said first conductor,
said waist in contact with said second conductor and said top end and said bottom end in contact with said first conductor such that said second conductor takes a plurality of longitudinal positions within said first conductor while maintaining electrical communication between said first conductor and said second conductor.
